(19) United States
(12) Patent Application Publication
(10) Pub. No.: US 2006/0117023 A1
(43) Pub. Date: Jun. 1, 2006

(54) Security procedure

(76) Inventor: David R. Tufto, Grandview, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/291,576

(22) Filed: Dec. 1, 2005

Related U.S. Application Data
(60) Provisional application No. 60/632,054, filed on Dec. 1, 2004.

(51) Int. Cl. G06F 17/30

(52) U.S. Cl. 707/10

(57) ABSTRACT

A security method for a computer program that can display web pages. A first web page calls a second web page, and the computer consults an array, such as in tabular format, containing data regarding which web pages are permitted to call other web pages. The array is inaccessible from the computer program that displays the web pages. The computer displays the second web page if the array contains data that permit the first web page to call the second web page, but does not display the second web page if the array does not contain data that permit the first web page to call the second web page.

### CROSS-REFERENCES TO RELATED APPLICATIONS

This application claims the benefit of U.S. Provisional Application No. 60/632,054 filed Dec. 1, 2004.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates to a security enhancement procedure that can be executed from within a database computer program.

2. Description of the Related Art

Entities that own shopping centers, hotels, commercial office parks, airports, manufacturing facilities and universities, among other facilities, have many incident types, such an automobile theft or person falling and being injured, that occur at these facilities. For each such incident, an incident report is conventionally created and faxed to an insurance company in order to report the incident. Such reports are required by most insurance policies providing coverage of such facilities.

With some computer software, one can fill in such a report and then transmit the report to the insurance company electronically, such as by email or using a web page. This software can permit users to search by field (e.g., date), prepare reports about incidents, and attach photos, video or anything else to the report. The data in the reports can be accessed over the web by password.

A URL (Uniform Resource Locator) represents a given web page in the user's browser that is viewing the data in the computer software. One security problem that exists with this software is that by changing the URL in the browser, a user can obtain access to data (on web pages) to which he or she may not legitimately have access. This can arise due to “URL Tampering” (deliberately attempting to access other web pages) and by legitimate users who may only have access to the records for a predetermined number of records but who stumble upon other records. If users can get access to other data by changing the URL in the software, this creates a security concern.

Conventionally, web-based database security has been provided by authenticating against the database server on each web page request, usually by login name and password. In order for a “calling” web page (i.e., a web page that a user is viewing when he or she enters instructions into the browser to display another web page) to access a “called” web page (i.e., a web page that the browser has been instructed to display), the called web page has to contain instructions in computer code that permit it to be called by the calling page. Without instructions, which can be considered “permission”, the calling page cannot call the called page, and therefore the browser cannot display the called page. However, the computer code that constitutes “permission” is visible to the user because it is part of the web page's HTML (hyper text markup language) code. This means that the code can be modified, and security can thereby be breached. Thus, the visibility on the web server of the permitted relationships is a security concern.

It is well known that SQL databases have tables of information that store data in rows and columns. Each physical web page is given a database identification value (database identifier). There is a need for a database that uses HTML programming so that it is accessible over the internet, but which is secure, unlike conventional internet-accessible databases.

### BRIEF SUMMARY OF THE INVENTION

In the invention, the software uses conventional html programming on the web pages (and, therefore, web server), but has additional steps that add security. This is, in part, due to the fact that there is data accessed in those additional steps that is only on the database server. Thus, there is no way for a user who does not have access to the database server to determine which web pages can call particular other web pages. There is also no way to accidentally or deliberately view a web page that is restricted, such as by changing the URL, because permission must be “granted” in order to view any page.

### BRIEF DESCRIPTION OF THE SEVERAL VIEWS OF THE DRAWINGS

FIG. 1 is a table illustrating the URLs of calling and called pages.

FIG. 2 is a table that contains rows that contain a calling file's database identifier and another file's database identifier that can call that file.

FIG. 3 illustrates a prepared statement that checks the FIG. 2 table for permitted relationships, and prevents the display of web pages that do not contain the permitted/associative relationship.

FIG. 4 is illustrates a function that is used in the example of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

The invention is a security enhancement procedure that can be executed from within a database. The present invention is embodied in software that uses the invention. It will be understood by persons having ordinary skill that the procedures described herein can be used in other, non-software procedures, and the software described herein can be modified and enhanced in such ways as to change their functionality but while retaining the essential elements of the invention. The following description is one example of the implementation of the method for increasing security in a computer program. It will become apparent to the person having ordinary skill that there may be many other embodiments of the invention.

The invention works with SQL databases. As is well-known, SQL databases permit stored procedures (sprocs) to be executed. When a user is in a web page, he or she can click on a hyperlink or enter a URL in the browser to access another web page. The invention relates to the method by which the browser is permitted to call and display the web page called.

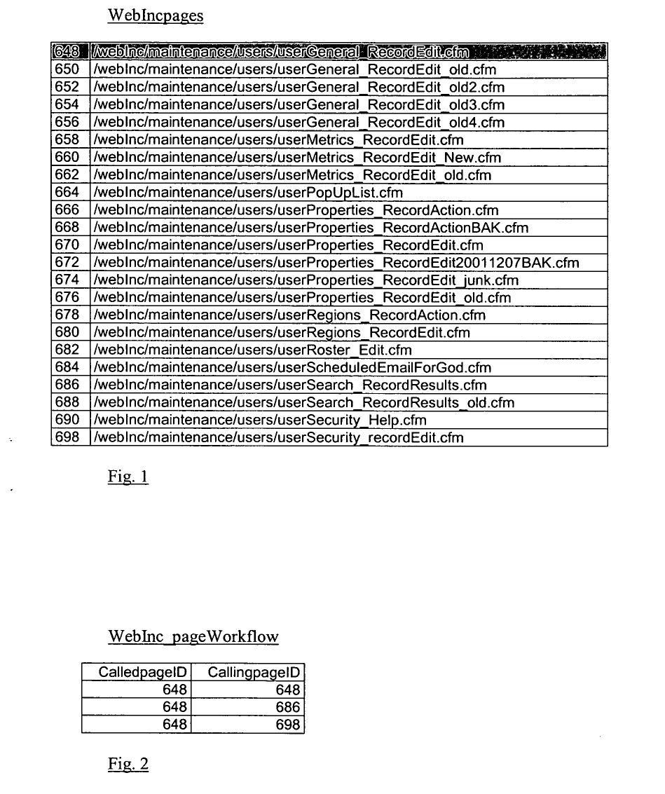

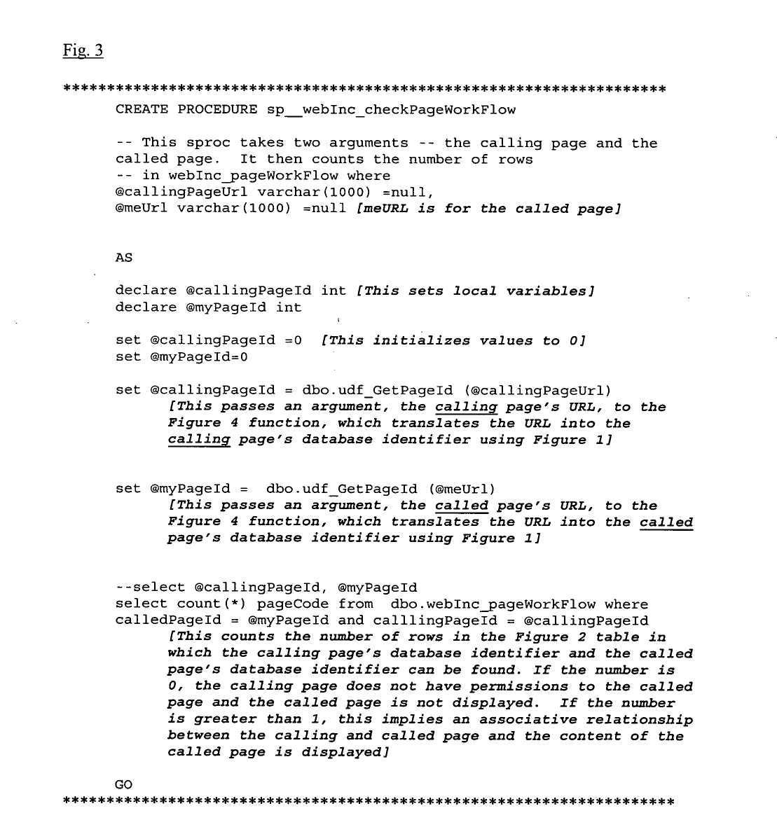

In the example, there is a table on the database server called “webIncpages” (see FIG. 1) that holds all of the files in the \webInc\maintenance\*.cfm templates. Each file represents a web page in this example. All files in \webInc\maintenance exist in this table to ease loading. The FIG. 1 table needs only to be created for the “edit” templates, which are those templates that are responsible for rendering the information to be viewed or edited. The “action” templates, which are those templates that are responsible for acting on the created or changed data, are not exposed and each referrer can be trapped with CGI functions.

For example, in webIncPages, database identifier 648 represents the file “/webInc/maintenance/users/userGeneral_RecordEdit.cfm.” This file is presented in the browser whenever this web page is called and there is permission granted by the invention for this web page to be called as discussed below. Of course, any other number or other identifier could be used for this particular file.

There is also a table in the database server called “WebInc_pageWorkflow” (see FIG. 2) that contains a plurality of rows, each of which contains a calling file's database identifier and another file's database identifier (often termed the “called file”) that can call that file. The FIG. 2 table can be considered a table containing the “rules” regarding whether a calling page is permitted to call a called page. These “rules” can be changed easily and quickly by simply adding, deleting or modifying one or more rows thereof. In the prior art, the only way to modify such rules is to modify any web page's html and other application source code. However, in the invention these rules are modified in one place, and do not depend on the application server environment, such as Microsoft .Net, Java, Macromedia MX, etc.

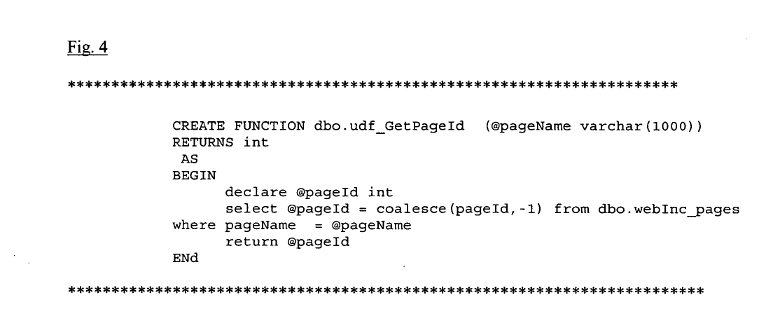

As shown in FIG. 1, the number 686 is the database identifier for the file (i.e., web page) “/webInc/maintenance/users/userSearch_RecordResults.cfm.” 698 is the database identifier for the file (i.e., web page) “/webInc/maintenance/users/userSecurity_RecordEdit.cfm.” So, the rules reflected in FIG. 2 permit page 648 (userGeneral) to be called from page 648 (itself), page 686 (userSearch), and page 698 (userSecurity). Thus, FIG. 2 lists the permissible calling and called page relationship for the database. Once the rules have been established, the function in FIG. 4 determines the database identifiers for the “calling” and “called” pages, and then a database stored procedure or other executable process can validate and enforce these rules. That is described immediately below.

A page is called by executing the instructions that will present the page on the browser, and that is initiated by clicking on a hyperlink or entering a URL into the browser from a given web page. Thus, when a user is viewing page 686 (userSearch results page) and he or she instructs the browser to access page 648 (userGeneral) by clicking on a hyperlink, the database has to determine whether it is permissible to call up page 648 from page 686. If so, the page can be loaded into the browser. If not, an error message is given, and the page cannot be loaded. The same applies when viewing page 698 (userSecurity), and trying to access page 648.

Thus, the procedure involves the step of determining whether the table of FIG. 2 permits the browser to take steps between particular web pages. The browser is only permitted access to a particular web page from a limited number of other web pages. It does so by resolving the URL of the called page and the URL of the calling page down to single numeric identifiers and then checking for an associative relationship established in FIG. 2.

When the user clicks on a hyperlink or enters a URL in the present invention, the program executes the sproc called webInc_checkPageWorkFlow, the basic instructions of which are reproduced as FIG. 3. In essence, the sproc of FIG. 3 takes the URLs of the calling and called pages as shown in FIG. 1, and, within the sproc, assigns each their respective database identifiers from FIG. 1. Then the sproc “consults” FIG. 2 to determine whether there is a row in FIG. 2 where the calledpageID is the database identifier for the called page URL, and the callingpageID is the database identifier for the calling page URL. If there is a row that includes that relationship (i.e., if the calling page is permitted to call the called page), then the relationship is permitted, and the called page is displayed on the browser. If not, the called page is not displayed.

Thus, the FIG. 2 table lists the associate relationships permitted between the called and calling page URLs, and, upon execution of the sproc of FIG. 3, which checks the FIG. 2 table for permitted relationships, the browser is permitted to display the called page when the calling page calls it. The sproc of FIG. 3 also returns an error condition that prevents rendering of non-permitted web pages.

In order to display a web page, the calling web page must have “permission” to call the called web page. Permission is granted in a function that is carried out separate from the web page in the database server. This function therefore cannot be circumvented or modified by anyone without access to execute instructions on the database server. Thus, the invention relates to the method by which the browser is permitted to call and display the web page called.

In the invention, the only step necessary to modify which calling pages can call which called pages is by changing the content (rows) of a single table, such as is shown in FIG. 2. In the prior art, every related web page's html or application source code must be changed. The conventional method is not only ripe for security breaches, it is also difficult to update and maintain as added functionality is introduced to the application.

While certain preferred embodiments of the present invention have been disclosed in detail, it is to be understood that various modifications may be adopted without departing from the spirit of the invention or scope of the following claims.

1. A security method for a computer program that can display at least a first and a second web page, the method comprising:
(a) the first web page calling the second web page;
(b) consulting an array containing data regarding which web pages are permitted to call other web pages, said array being inaccessible from the computer program that displays the web pages;
(c) displaying the second web page if the array contains data that permit the first web page to call the second web page; and
(d) not displaying the second web page if the array does not contain data that permit the first web page to call the second web page.

2. The security method in accordance with claim 1, further comprising modifying the data in the array.
